(19) United States
(12) Patent Application Publication
(10) Pub. No.: US 2013/0144935 A1
(43) Pub. Date: Jun. 6, 2013

(54) System and Method for Running an Internet Server Behind a Closed Firewall

(71) Applicant: Luiz Claudio Valdetaro, Coppell, TX (US)

(72) Inventor: Luiz Claudio Valdetaro, Coppell, TX (US)

(73) Assignee: VERTICAL COMPUTER SYSTEMS, INC., Richardson, TX (US)

(21) Appl. No.: 13/491,372

(22) Filed: Jun. 7, 2012

Related U.S. Application Data
(63) Continuation-in-part of application No. 12/966,741, filed on Dec. 13, 2010.
(60) Provisional application No. 61/494,407, filed on Jun. 7, 2011.

(51) Int. Cl. H04L 29/06

(52) U.S. Cl. CPC H04L 63/02
USPC 709/203

(57) ABSTRACT

A system for running an Internet server behind a closed firewall, wherein a relay agent (RA) is coupled through a closed firewall to relay server software (RSS) for initiating communications with the RSS, receiving an end-user request from the RSS, for forwarding the end-user request to an Internet server, for receiving a response from the Internet server, and for forwarding the response to the RSS for forwarding to an end-user client software.

### CROSS-REFERENCE TO RELATED APPLICATION

This application is a continuation-in-part of U.S. patent application Ser. No. 12/966,741, filed Dec. 13, 2010, and claims the benefit of U.S. Provisional Application No. 61/494,407, filed Jun. 7, 2011, both of which applications are hereby incorporated herein by reference, in their entirety.

### TECHNICAL FIELD

The invention relates generally to the Internet and, more particularly, to securing servers on the Internet.

### BACKGROUND

Transmission Control Protocol/Internet Protocol (“TCP/IP”) connections always have at least a client at one endpoint of the connection and a server at the other endpoint. The only difference between those two points is that the client must initiate the connection, and the server must accept that initiation. Once the communication is established either side can send and receive data from the other.

A firewall is essentially like a one-way mirror. Computers behind or inside the firewall can “see” (i.e., initiate connections) with computers on the “front” side or outside of the firewall, but computers outside the firewall cannot “see” (i.e., initiate connections) with computers behind (inside) the firewall. Accordingly, a first computer inside the firewall can be invisible to a second computer outside the firewall, but the first computer can initiate a connection with the second computer, and the second computer cannot initiate a connection with the first computer. It is understood that, as the terms are used herein, computers that initiate a connection are referred to as “clients,” and computers that receive a connection are referred to as “servers.”

A firewall can have “port openings”, equivalent to drilling a hole on the one-way mirror. In a one-way mirror with a drilled-on hole, someone on the mirror side can “peek” through the hole and see the other side. Similarly, once a port is opened on the firewall, computers outside of the firewall can initiate connections with the computers inside of the firewall. This is how most servers are hosted: they are behind a firewall with port openings.

A firewall with port openings is referred to herein as being an “open firewall” and a firewall without port openings is referred to herein as being a “closed firewall”.

It can be appreciated that port openings present a security risk which, for example, make a server inside an open firewall vulnerable to attack by “hackers”. A closed firewall is more secure, but does not allow clients outside of the firewall to connect to servers behind the firewall.

In another technology, namely, a Virtual Private Network (VPN), a user can, for example, initiate a connection to a remote computer at his office via VPN. After that is done, a user at the office will “see” any server software that the user has on his home computer. Thus, even if the user's home computer is behind a closed firewall, it is possible to run a server on his home computer that would be accessible to people on his office network. However, a drawback with VPN is that it does not enable a server that is accessible by anyone on the Internet to be run behind a closed firewall. Moreover, VPN does not aid with security, because VPN “virtually” moves the user's home PC to the employer's network, potentially exposing all of the user's home computer.

Therefore, what is needed is a system and method for running a server behind a closed firewall.

### SUMMARY

The present invention, accordingly, provides a system and method for running a server and, more particularly, an Internet server, behind a closed firewall. It achieves this objective using relay server software outside the closed firewall and an Internet device (“ID”) behind the closed firewall, the Internet device preferably including a relay agent and the Internet server.

In operation, the Internet server behind the closed firewall is coupled to a relay agent (RA) operating behind the closed firewall, and operation includes steps performed by the RA of initiating a connection with a relay server software (RSS) operating outside of the closed firewall, receiving an end-user request from the RSS, forwarding the end-user request to an Internet server; receiving a response from the Internet server; and forwarding the response to the RSS for forwarding to the client computer.

In a further embodiment, a relay agent (RA) operating behind a closed firewall includes at least a processor and a memory operably coupled to the processor, the memory being configured for storing a computer program executable by the processor. The computer program includes computer program code for: initiating a connection with relay server software (RSS) operating outside of the closed firewall and coupled to a client computer operable by an end-user; receiving an end-user request from the RSS; forwarding the end-user request to an Internet server operating behind the closed firewall; receiving a response from the Internet server; and forwarding the response to the RSS for forwarding to the client computer.

In addition to enabling a server to run behind a closed firewall, other advantages include enhanced security, because the server running on the ID is invisible to end users (clients) at all times, creating a “super” firewall.

Another advantage of the invention is that it can facilitate management of server farms. Sometimes, in large installations, there are multiple levels of firewalls, and managing the port openings and other networking settings can be a complex task. This invention simplifies that tremendously.

A still further advantage of the invention is that it can be used for a distributed “cloud” offering, such as a distributed peer-to-peer social network, a distributed peer-to-peer (serverless) e-mail system, a corporate system to control mobile devices, and the like.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 exemplifies a high-level conceptual block diagram illustrating an Internet server running behind a closed firewall, in accordance with principles of the present invention;

FIG. 2 exemplifies an alternative embodiment of the Internet server of FIG. 1, in accordance with principles of the present invention; and

FIG. 3 is a flow chart exemplifying steps for implementing features of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

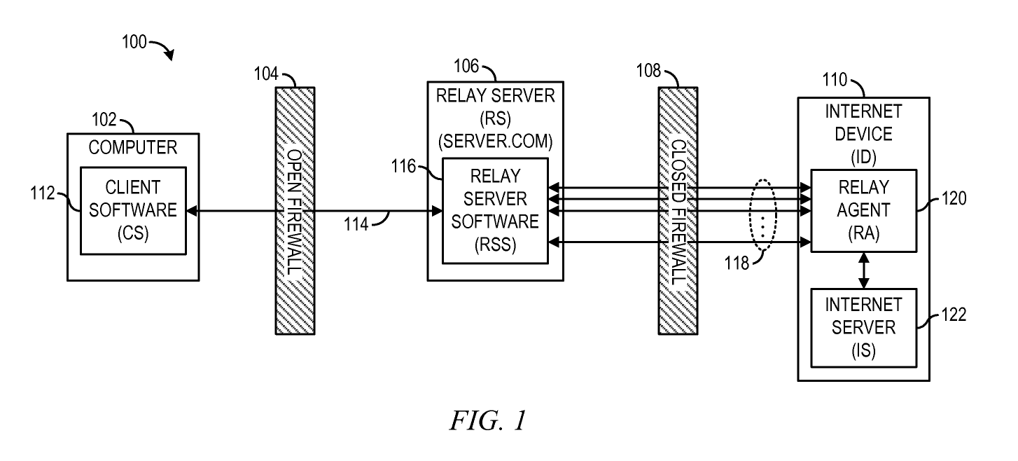

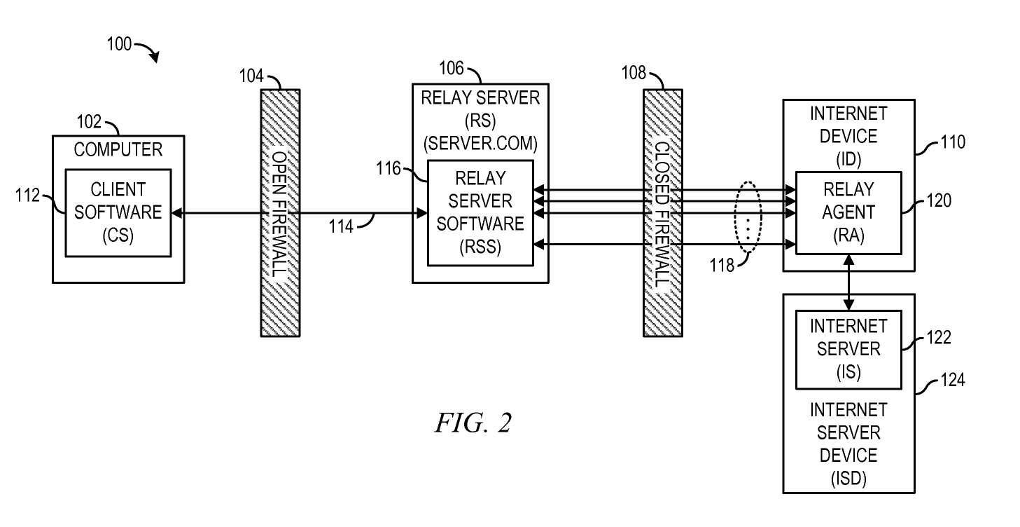

Referring to FIG. 1 of the drawings, the reference numeral 100 generally designates a system embodying features of the present invention. The system 100 includes a client computer 102 (e.g., a personal computer) operable by an end user (not shown), a relay server (RS) 106 coupled to the client computer 102, and an Internet device (ID) 110 (e.g., any computing device with networking capability, such as, by way of example but not limitation, computers such as servers, desktop computers, laptop computers, and mobile Internet devices such as tablets and smartphones, and the like) coupled to the RS 106. The client computer 102 includes client software 112 configured for communication with the RS 106. The RS 106 includes relay server software (RSS) 116 coupled, preferably behind an open firewall 104, via a communications link (wireline or wireless) 114 to the client software (CS) 112. The ID 110 includes a relay agent (RA) 120 and an Internet server (IS) 122 coupled to the RA 120. The RA 120 is coupled behind a closed firewall 108 via one or more communication links (wireline or wireless) 118 to the RSS 116. It is noted that, even though the RA 120 and IS 122 are depicted in the drawing as running on the same computer, it is not necessary that they run on the same computer. For example, as depicted by FIG. 2, the IS 122 may be located on a separate computer, such as in an Internet server device (ISD) 124, apart from the ID 110. The IS 122 is preferably operable on any of a number of different protocols, such as, by way of example, but not limitation, Hypertext Transfer Protocol (HTTP), Hypertext Transfer Protocol Secure (HTTPS), File Transfer Protocol (FTP), Secure File Transfer Protocol (SFTP), Network News Transfer Protocol (NNTP), Simple Mail Transfer Protocol (SMTP), Internet Message Access Protocol (IMAP), Internet Control Message Protocol (ICMP), Secure Shell (SSH) protocol, Telnet, Gopher, and/or Read and Write (RAW) protocol communications or proprietary protocols.

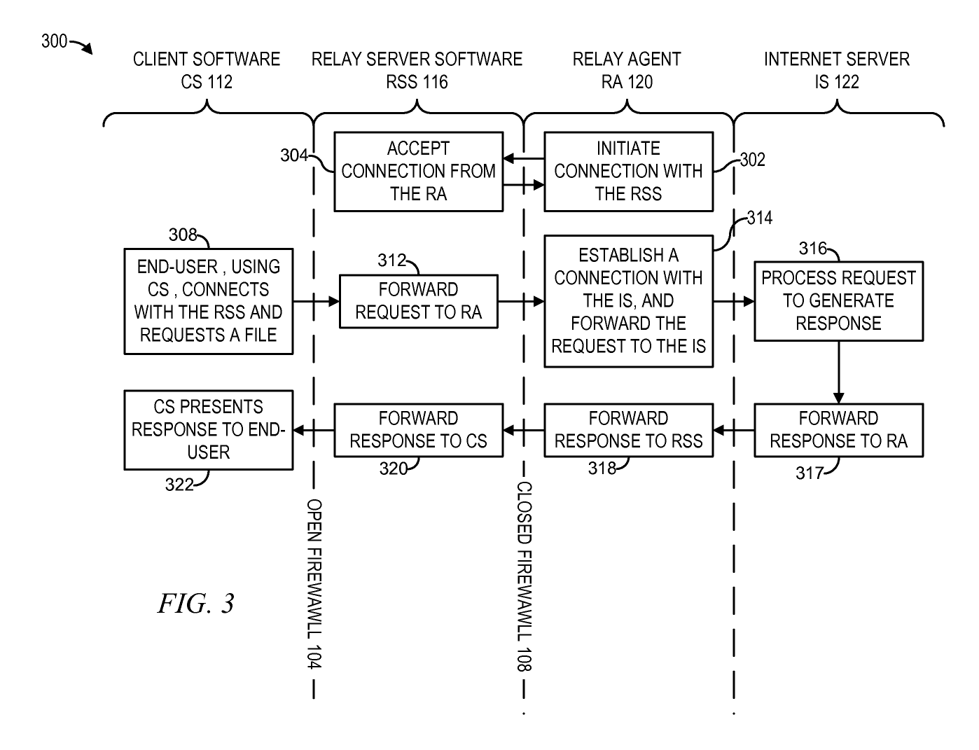

FIG. 3 depicts a flowchart 300 of steps preferred for operation of the invention. In step 302, the RA 120 initiates one or more “permanent” connections with the RSS 116 for handling one or more concurrent end-user computers 102. The RA 120 and RSS 116 then act as a “tunnel” whereby computers 102 outside of the firewalls 104 and 108 can access information provided by one or more IS's 122 inside of the firewalls 104 and 108, without ever having access to those servers or a connection to it. It is noted that, because the ID 110 (including the RA 120) resides behind the closed firewall 108, it must initiate the connection with the RSS 116; and the RA 120 will be the “client” on the connection, with the RSS 116 being the “server.”

In step 304, the RSS 116 accepts connection from the RA 120. Important to note is that in this connection, the “Client” is the RA 120, and the “Server” is the RSS 116, even though the intent (discussed below) is for the RSS 116 to forward requests to the RA 120. This connection is preferably a permanent connection and should preferably stay open for as long as the RS 106 and the ID 110 are operational and communicating. The RSS 116 will then send a message to the RA 120 acknowledging acceptance of the connection. Optionally, the RSS 116 may demand credentials from the RA 120 for security authentication. The RSS 116 then waits for connections from an end-user (not shown) client computer 102 running client software 112.

In step 308, the end-user, using CS 112, connects with the RSS 116, which resides on the RS 106 and has a domain name of, for example, SERVER.COM. The end-user then requests a file, such as, by way of example but not limitation, http://server.com/doc.html.

In step 312, the RSS 116 receives the request from the CS 112, forwards the request to the RA 120 through one of the connections established in step 302, and waits for the response.

In step 314, the RA 120 receives the request from the RSS 116, establishes a connection with the IS 122, and forwards the request to the IS 122.

In step 316, the IS 122 receives the request from the RA 120 , and processes the request (e.g., to send back a file named doc.html, requested at step 308) to generate a response (e.g., including the file named doc.html). In step 317, the IS 122 forwards the response back to the RA 120.

In step 318, the RA 120 receives the response from the IS 122, and forwards it back to the RSS 116 through the same connection where the request was originally sent from the RSS 116 at step 312. It is important that the same connection is used, because if there are multiple users making separate requests and they are sent on different connections, the responses will ultimately go to the wrong end-user.

In step 320, the RSS 116 receives the response from the RA 120 and sends it to the CS 112.

In step 322, the CS 112 presents the response to the end-user, for example, by displaying the file doc.html to the end-user.

It is understood that the present invention may take many forms and embodiments. Accordingly, several variations may be made in the foregoing without departing from the spirit or the scope of the invention. For example, one could use User Datagram Protocol (UDP) instead of TCP, or even some other low-level non-routable communication protocol such as Netbios, Systems Network Architecture (SNA), or the like.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for running an Internet server behind a closed firewall, the system comprising:
a relay server;
relay server software (RSS) operable on the relay server, the RSS being connectable through an open firewall to client software executable on a client computer;
a closed firewall;
an Internet device;
a relay agent (RA) operable on the Internet device and coupled to the RSS through the closed firewall for initiating communications with the RSS; and
an Internet server coupled to the RA.

2. The system of claim 1 wherein the Internet server is operable on the Internet device.

3. The system of claim 1 further comprising an Internet server device, and wherein the Internet server is operable on the Internet server device.

4. The system of claim 1 wherein the Internet server is operable in accordance with Hypertext Transfer Protocol (HTTP).

5. The system of claim 1 wherein the Internet server is operable in accordance with Hypertext Transfer Protocol Secure (HTTPS).

6. The system of claim 1 wherein the Internet server is operable in accordance with File Transfer Protocol (FTP).

7. The system of claim 1 wherein the Internet server is operable in accordance with Secure File Transfer Protocol (SFTP).

8. The system of claim 1 wherein the Internet server is operable in accordance with Network News Transfer Protocol (NNTP).

9. The system of claim 1 wherein the Internet server is operable in accordance with Simple Mail Transfer Protocol (SMTP).

10. The system of claim 1 wherein the Internet server is operable in accordance with Internet Message Access Protocol (IMAP).

11. The system of claim 1 wherein the Internet server is operable in accordance with Internet Control Message Protocol (ICMP).

12. The system of claim 1 wherein the Internet server is operable in accordance with Secure Shell (SSH) protocol.

13. The system of claim 1 wherein the Internet server is operable in accordance with Telnet protocol.

14. The system of claim 1 wherein the Internet server is operable in accordance with Gopher protocol.

15. The system of claim 1 wherein the Internet server is operable in accordance with Read and Write (RAW) protocol.

16. A method for operating an Internet server behind a closed firewall, the Internet server being coupled to a relay agent (RA) operating behind the closed firewall, the method comprising steps performed by the RA of:
initiating a connection with relay server software (RSS) operating outside of the closed firewall and coupled to a client computer operable by an end-user;
receiving an end-user request from the RSS;
forwarding the end-user request to an Internet server;
receiving a response from the Internet server; and
forwarding the response to the RSS for forwarding to the client computer.

17. The method of claim 16 wherein the step of forwarding the end-user request to the Internet server further comprises establishing a connection between the RA and the Internet server.

18. The method of claim 16 wherein the Internet server is operable in accordance with Hypertext Transfer Protocol (HTTP).

19. The method of claim 16 wherein the Internet server is operable in accordance with Hypertext Transfer Protocol Secure (HTTPS).

20. The method of claim 16 wherein the Internet server is operable in accordance with File Transfer Protocol (FTP).

21. The method of claim 16 wherein the Internet server is operable in accordance with Secure File Transfer Protocol (SFTP).

22. The method of claim 16 wherein the Internet server is operable in accordance with Network News Transfer Protocol (NNTP).

23. The method of claim 16 wherein the Internet server is operable in accordance with Simple Mail Transfer Protocol (SMTP).

24. The method of claim 16 wherein the Internet server is operable in accordance with Internet Message Access Protocol (IMAP).

25. The method of claim 16 wherein the Internet server is operable in accordance with Internet Control Message Protocol (ICMP).

26. The method of claim 16 wherein the Internet server is operable in accordance with Secure Shell (SSH) protocol.

27. The method of claim 16 wherein the Internet server is operable in accordance with Telnet protocol.

28. The method of claim 16 wherein the Internet server is operable in accordance with Gopher protocol.

29. The method of claim 16 wherein the Internet server is operable in accordance with Read and Write (RAW) protocol.

30. A relay agent (RA) operating behind a closed firewall includes at least a processor and a memory operably coupled to the processor, the memory being configured for storing a computer program executable by the processor, the computer program comprising:
computer program code for initiating a connection with relay server software (RSS) operating outside of the closed firewall and coupled to a client computer operable by an end-user;
computer program code for receiving an end-user request from the RSS;
computer program code for forwarding the end-user request to an Internet server operating behind the closed firewall;
computer program code for receiving a response from the Internet server; and
computer program code for forwarding the response to the RSS for forwarding to the client computer.

31. The RA of claim 30 wherein the computer program code for forwarding the end-user request to the Internet server further comprises computer program code for establishing a connection between the RA and the Internet server.

32. The RA of claim 30 wherein the Internet server is operable in accordance with Hypertext Transfer Protocol (HTTP).

33. The RA of claim 30 wherein the Internet server is operable in accordance with Hypertext Transfer Protocol Secure (HTTPS).

34. The RA of claim 30 wherein the Internet server is operable in accordance with File Transfer Protocol (FTP).

35. The RA of claim 30 wherein the Internet server is operable in accordance with Secure File Transfer Protocol (SFTP).

36. The RA of claim 30 wherein the Internet server is operable in accordance with Network News Transfer Protocol (NNTP).

37. The RA of claim 30 wherein the Internet server is operable in accordance with Simple Mail Transfer Protocol (SMTP).

38. The RA of claim 30 wherein the Internet server is operable in accordance with Internet Message Access Protocol (IMAP).

39. The RA of claim 30 wherein the Internet server is operable in accordance with Internet Control Message Protocol (ICMP).

40. The RA of claim 30 wherein the Internet server is operable in accordance with Secure Shell (SSH) protocol.

41. The RA of claim 30 wherein the Internet server is operable in accordance with Telnet protocol.

42. The RA of claim 30 wherein the Internet server is operable in accordance with Gopher protocol.

43. The RA of claim 30 wherein the Internet server is operable in accordance with Read and Write (RAW) protocol.
